(19) United States
(12) Patent Application Publication
(10) Pub. No.: US 2026/0160280 A1
(43) Pub. Date: Jun. 11, 2026

(54) HYDRAULICALLY POWERED POWER SYSTEMS FOR CONTROLLING VARIABLE DISPLACEMENT HYDRAULIC PUMPS AND VARIABLE DISPLACEMENT HYDRAULIC MOTORS

(71) Applicant: Illinois Tool Works Inc., Glenview, IL (US)

(72) Inventor: Nathan Joe Jochman, Menasha, WI (US)

(21) Appl. No.: 19/416,160

(22) Filed: Dec. 11, 2025

Related U.S. Application Data
(60) Provisional application No. 63/730,800, filed on Dec. 11, 2024.

(51) Int. Cl. F15B 17/02

(52) U.S. Cl. CPC F15B 17/02; F15B 2211/20546; F15B 2211/6654; F15B 2211/6655

(57) ABSTRACT

A hydraulically powered power system comprises: a variable displacement hydraulic pump configured to receive input power from an engine or an electric motor and to convert the input power to an input hydraulic flow; a hydraulic motor configured to convert the input hydraulic flow to motor power; a compressor configured to receive the motor power to generate a pneumatic output; and control circuitry configured to: calculate a flow adjustment based on a target pneumatic output of the compressor; and upon calculating the flow adjustment, output a pump control signal to control the variable displacement hydraulic pump to modify a pump operating characteristic of the variable displacement hydraulic pump based on the flow adjustment.

### RELATED APPLICATIONS

The present application claims the benefit of U.S. Provisional Patent Application Ser. No. 63/730,800, filed Dec. 11, 2024, entitled “HYDRAULICALLY POWERED POWER SYSTEMS FOR CONTROLLING VARIABLE DISPLACEMENT HYDRAULIC PUMPS AND VARIABLE DISPLACEMENT HYDRAULIC MOTORS.” The entirety of U.S. Provisional Patent Application Ser. No. 63/730,800 is expressly incorporated herein by reference.

### FIELD OF THE DISCLOSURE

This disclosure relates generally to hydraulically powered power systems and, more particularly, to hydraulically powered power systems for controlling variable displacement hydraulic pumps and/or variable displacement hydraulic motors.

### BACKGROUND

Hydraulically powered power systems use hydraulic fluid to generate power. For example, a hydraulically powered power system may include a hydraulic pump which pumps hydraulic fluid through a hydraulic circuit comprising a hydraulically powered device. The hydraulic pump may power a hydraulically driven motor (e.g., a “hydraulic motor”), thereby actuating the hydraulic motor to generate and output mechanical power to a mechanically powered device.

### SUMMARY

Hydraulically powered power systems for controlling one or more operating characteristics of a variable displacement hydraulic pump and/or a variable displacement hydraulic motor are disclosed, substantially as illustrated by and described in connection with at least one of the figures, as set forth more completely in the claims.

### BRIEF DESCRIPTION OF THE DRAWINGS

FIG. 1A illustrates a block diagram of an example of a hydraulically powered power system having a variable displacement hydraulic pump and a variable displacement hydraulic motor, in accordance with aspects of this disclosure;

FIG. 1B illustrates a block diagram of an example of a hydraulically powered power system having a variable displacement hydraulic pump and a fixed displacement hydraulic motor, in accordance with aspects of this disclosure;

FIG. 1C illustrates a block diagram of an example of a hydraulically powered power system having a fixed displacement hydraulic pump and a variable displacement hydraulic motor, in accordance with aspects of this disclosure;

FIG. 2 illustrates a block diagram of an example of control circuitry of a hydraulically powered power system, in accordance with aspects of this disclosure; and

FIG. 3 illustrates a flowchart representative of an exemplary process for controlling a hydraulically powered power system and/or one or more components thereof, in accordance with aspects of this disclosure.

The figures are not necessarily to scale. Where appropriate, similar or identical reference numbers are used to refer to similar or identical components.

### DETAILED DESCRIPTION

Disclosed example hydraulically powered power systems include hydraulic circuits which provide hydraulic power (e.g., input hydraulic flow of a hydraulic fluid) and/or motor power (e.g., rotation of a drive shaft) to power output equipment, such as a generator, an air compressor, a motor, and/or one or more other hydraulically-, mechanically-, and/or electrically-powered devices. However, an operator of the output equipment may desire to change an output of the output equipment, and the output of the output equipment may be a function of a magnitude of power received by the output equipment. For example, rotational speed of a drive shaft providing a motor power to a generator can determine a voltage and/or frequency of an electrical output of the generator. As another example, rotational speed of a drive shaft providing motor power to an air compressor determines a flow rate of air output by the air compressor.

Accordingly, disclosed example hydraulically powered power systems include one or more variable displacement hydraulic pumps and/or one or more variable displacement hydraulic motors and modify one or more pump operating characteristics of the one or more variable displacement hydraulic pumps and/or one or more motor operating characteristics of the one or more variable displacement hydraulic motors to modify an operating characteristic of output equipment powered by a hydraulic circuit of the disclosed example hydraulically powered power systems. For example, modifying a pump operating characteristic of a variable displacement hydraulic pump (e.g., a pump displacement, a pump speed, a pump torque, a flow rate and/or flow velocity of input hydraulic flow generated by the variable displacement hydraulic pump, etc.) can modify a magnitude of hydraulic power generated by the variable displacement hydraulic pump and/or a magnitude of motor power generated by a hydraulic motor hydraulically powered by the variable displacement hydraulic pump. As an additional and/or alternative example, modifying a motor operating characteristic of a variable displacement hydraulic motor (e.g., a hydraulic displacement rate, a hydraulic pressure, a torque and/or motor speed of motor power generated by the variable displacement hydraulic motor, etc.) can modify a magnitude of motor power generated by the variable displacement hydraulic motor. By including and controlling either or both of one or more variable displacement hydraulic pumps and/or one or more variable displacement hydraulic motors, disclosed example hydraulically powered power systems can, thereby, modify one or more operating characteristics of output equipment of the hydraulically powered power system.

By including and controlling either or both of one or more variable displacement hydraulic pumps and/or one or more variable displacement hydraulic motors, operation of output equipment and modification of one or more operating characteristics of output equipment can be made more efficient. For example, typical systems throttle a flow rate of air entering an air compressor to control the output of the air compressor. Similarly, typical systems throttle a flow rate of hydraulic fluid entering a crane to control a movement speed of the crane. Modifying output of an air compressor or a crane in such ways can be inefficient, e.g., because the power source powering the air compressor or the crane is generating unused power. However, disclosed example hydraulically powered power systems can reduce or eliminate a need to throttle air to an air compressor powered by a hydraulic circuit and/or throttle hydraulic flow to a crane powered by a hydraulic circuit by, instead, modifying one or more pump operating characteristics of a variable displacement hydraulic pump of the hydraulic circuit and/or by modifying one or more motor operating characteristics of a variable displacement hydraulic motor of the hydraulic circuit.

Disclosed example hydraulically powered power systems comprise: a variable displacement hydraulic pump configured to receive input power from an engine or an electric motor and to convert the input power to an input hydraulic flow; a hydraulic motor configured to convert the input hydraulic flow to motor power; a compressor configured to receive the motor power to generate a pneumatic output; and control circuitry configured to: calculate a flow adjustment based on a target pneumatic output of the compressor; and upon calculating the flow adjustment, output a pump control signal to control the variable displacement hydraulic pump to modify a pump operating characteristic of the variable displacement hydraulic pump based on the flow adjustment.

In some example hydraulically powered power systems, the pump operating characteristic comprises at least one of a pump displacement of the variable displacement hydraulic pump, a pump speed of the variable displacement hydraulic pump, a pump torque of the variable displacement hydraulic pump, a piston force of the variable displacement hydraulic pump, a flow rate of the input hydraulic flow generated by the variable displacement hydraulic pump, or a flow velocity of the input hydraulic flow generated by the variable displacement hydraulic pump.

In some example hydraulically powered power systems, the control circuitry is further configured to: receive an input signal; and determine the target pneumatic output based on the input signal.

In some example hydraulically powered power systems, the hydraulically powered power system further comprises a hydraulic auxiliary device configured to receive the input hydraulic flow and to convert the input hydraulic flow to an output, wherein the calculating of the flow adjustment is further based on a target output of the hydraulic auxiliary device.

In some example hydraulically powered power systems, the hydraulically powered power system further comprises a hydraulic auxiliary device configured to convert the input hydraulic flow to an output, wherein the calculating of the flow adjustment is further based on a target output of the hydraulic auxiliary device.

In some example hydraulically powered power systems, the hydraulically powered power system further comprises a mechanical auxiliary device configured to receive the motor power to generate an output, wherein the calculating of the flow adjustment is further based on a target output of the mechanical auxiliary device.

In some example hydraulically powered power systems, the hydraulic motor is a variable displacement hydraulic motor; and the control circuitry is further configured to: calculate a motor power adjustment based on the target pneumatic output; and upon calculating the motor power adjustment, output a motor control signal to control the variable displacement hydraulic motor to modify a motor operating characteristic of the variable displacement hydraulic motor based on the motor power adjustment.

Disclosed example hydraulically powered power systems comprise: a variable displacement hydraulic motor configured to convert an input hydraulic flow to motor power; a compressor configured to receive the motor power to generate a pneumatic output; and control circuitry configured to: calculate a motor power adjustment based on a target pneumatic output of the compressor; and upon calculating the motor power adjustment, output a motor control signal to control the variable displacement hydraulic motor to modify a motor operating characteristic of the variable displacement hydraulic motor based on the motor power adjustment.

In some example hydraulically powered power systems, the motor operating characteristic comprises at least one of a hydraulic displacement rate of the variable displacement hydraulic motor, a hydraulic pressure of the variable displacement hydraulic motor, a torque of the motor power, or a motor speed of the motor power.

In some example hydraulically powered power systems, the motor power adjustment comprises at least one of a torque adjustment or a motor speed adjustment.

In some example hydraulically powered power systems, the control circuitry is further configured to: receive an input signal; and determine the target pneumatic output based on the input signal.

In some example hydraulically powered power systems, the hydraulically powered power system further comprises a mechanical auxiliary device configured to receive the motor power to generate an output, wherein the calculating of the motor power adjustment is further based on a target output of the mechanical auxiliary device.

In some example hydraulically powered power systems, the hydraulically powered power system further comprises a variable displacement hydraulic pump configured to receive input power from an engine or an electric motor and to convert the input power to the input hydraulic flow, wherein the control circuitry is further configured to: calculate a flow adjustment based on the target pneumatic output; and upon calculating the flow adjustment, output a pump control signal to control the variable displacement hydraulic pump to modify a pump operating characteristic of the variable displacement hydraulic pump based on the flow adjustment.

Disclosed example hydraulically powered power systems comprise: a variable displacement hydraulic pump configured to receive input power from an engine or an electric motor and to convert the input power to an input hydraulic flow; a hydraulic motor configured to convert the input hydraulic flow to motor power; a generator drivingly coupled to the hydraulic motor and configured to receive the motor power to generate an electrical output; a generator sensor configured to measure a generator operating characteristic of the generator and to generate a sensor signal comprising a measured generator operating characteristic associated with the generator operating characteristic; and control circuitry configured to: calculate a flow adjustment based on a target generator operating characteristic of the generator and the measured generator operating characteristic; and upon calculating the flow adjustment, output a pump control signal to control the variable displacement hydraulic pump to modify a pump operating characteristic of the variable displacement hydraulic pump based on the flow adjustment.

In some example hydraulically powered power systems, the generator operating characteristic comprises at least one of a voltage of the electrical output, a frequency of the electrical output, a current of the electrical output, or an operating speed of the generator.

In some example hydraulically powered power systems, the pump operating characteristic comprises at least one of a pump displacement of the variable displacement hydraulic pump, a pump speed of the variable displacement hydraulic pump, a pump torque of the variable displacement hydraulic pump, a piston force of the variable displacement hydraulic pump, a flow rate of the input hydraulic flow generated by the variable displacement hydraulic pump, or a flow velocity of the input hydraulic flow generated by the variable displacement hydraulic pump.

In some example hydraulically powered power systems, the control circuitry is further configured to: receive an input signal; and determine the target generator operating characteristic based on the input signal.

In some example hydraulically powered power systems, the hydraulically powered power system further comprises a hydraulic auxiliary device configured to convert the input hydraulic flow to an output, wherein the calculating of the flow adjustment is further based on a target output of the hydraulic auxiliary device.

In some example hydraulically powered power systems, the hydraulically powered power system further comprises a mechanical auxiliary device configured to receive the motor power to generate an output, wherein the calculating of the flow adjustment is further based on a target output of the mechanical auxiliary device.

In some example hydraulically powered power systems, the hydraulic motor is a variable displacement hydraulic motor; and the control circuitry is further configured to: calculate a motor power adjustment based on the target generator operating characteristic of the generator and the measured generator operating characteristic; and upon calculating the motor power adjustment, output a motor control signal to control the variable displacement hydraulic motor to modify a motor operating characteristic of the variable displacement hydraulic motor based on the motor power adjustment.

Disclosed example hydraulically powered power systems comprise: a variable displacement hydraulic motor configured to receive an input hydraulic flow and to convert the input hydraulic flow to motor power; a generator drivingly coupled to the variable displacement hydraulic motor and configured to receive the motor power to generate an electrical output; a generator sensor configured to measure a generator operating characteristic of the generator and to generate a generator sensor signal comprising a measured generator operating characteristic associated with the generator operating characteristic; and control circuitry configured to: calculate a motor power adjustment based on a target generator operating characteristic of the generator and the measured generator operating characteristic; and upon calculating the motor power adjustment, output a motor control signal to control the variable displacement hydraulic motor to modify a motor operating characteristic of the variable displacement hydraulic motor based on the motor power adjustment.

In some example hydraulically powered power systems, the generator operating characteristic comprises at least one of a voltage of the electrical output, a frequency of the electrical output, a current of the electrical output, or an operating speed of the generator.

In some example hydraulically powered power systems, the motor operating characteristic comprises at least one of a hydraulic displacement rate of the variable displacement hydraulic motor, a hydraulic pressure of the variable displacement hydraulic motor, a torque of the motor power, or a motor speed of the motor power.

In some example hydraulically powered power systems, the motor power adjustment comprises at least one of a torque adjustment or a motor speed adjustment.

In some example hydraulically powered power systems, the control circuitry is further configured to: receive an input signal; and determine the target generator operating characteristic based on the input signal.

In some example hydraulically powered power systems, the hydraulically powered power system further comprises a mechanical auxiliary device configured to receive the motor power to generate an output, wherein the calculating of the motor power adjustment is further based on a target output of the mechanical auxiliary device.

As used herein, the term “hydraulic power system” includes a system having a motor, a fluid reservoir, and a pump. The hydraulic power system applies hydraulic pressure to one or more devices and/or systems by generating a hydraulic flow of a hydraulic fluid through a hydraulic circuit to drive, e.g., motors, shafts, cylinders, and/or other parts of the one or more devices and/or systems.

As used herein, the term “hydraulic pump” describes a device to convert mechanical power into hydraulic energy, thereby serving as a source for mechanical power output, such as to a hydraulic motor. For example, a hydraulic pump may generate a hydraulic flow of a hydraulic fluid through a hydraulic circuit.

A hydraulic flow may be a function of one or more flow characteristics of a hydraulic fluid, such as a flow rate, a flow velocity, a pressure, a temperature, a heat output, and/or an oil weight of hydraulic fluid. The term “flow rate,” as used herein with respect to hydraulic flow, refers to the volume of hydraulic fluid transferred through a region per unit of time. For example, a “flow rate” of a hydraulic flow may be measured in cubic meters per second (“cms”), cubic feet per second (“cfs”), gallons per minute (“gpm”), etc. The term “flow velocity,” as used herein with respect to hydraulic flow, refers to the distance traveled by a hydraulic fluid per unit of time. For example, a “flow velocity” of a hydraulic flow may be measured in meters per second (“mps”), feet per second (“fps”), miles per hour (“mph”), etc.

As used herein, the term “hydraulic motor” includes any device capable of converting fluid flow into linear or rotary motion. Example hydraulic motors operate by converting fluid flow from a hydraulic pump into a rotary motion as a motor output shaft is driven by the pressurized fluid acting on one or more components of the hydraulic motor (e.g., gears, pistons, etc.).

As used herein, the term “output equipment” refers to one or more devices that receive power (e.g., input power, input hydraulic flow, motor power, an electrical output, welding-type power, etc.) from one or more systems (e.g., a hydraulically powered power system, a hydraulic circuit, etc.), devices (e.g., a power source, a hydraulic pump, a hydraulic motor, a generator, power conversion circuitry), and/or components to generate an output (e.g., one or more type(s) of power and/or functions produced using the received power).

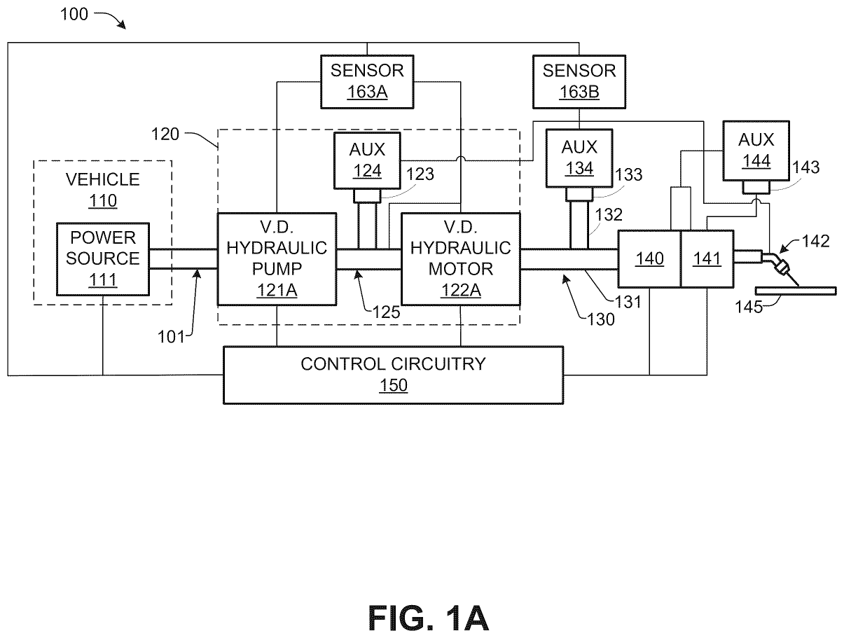

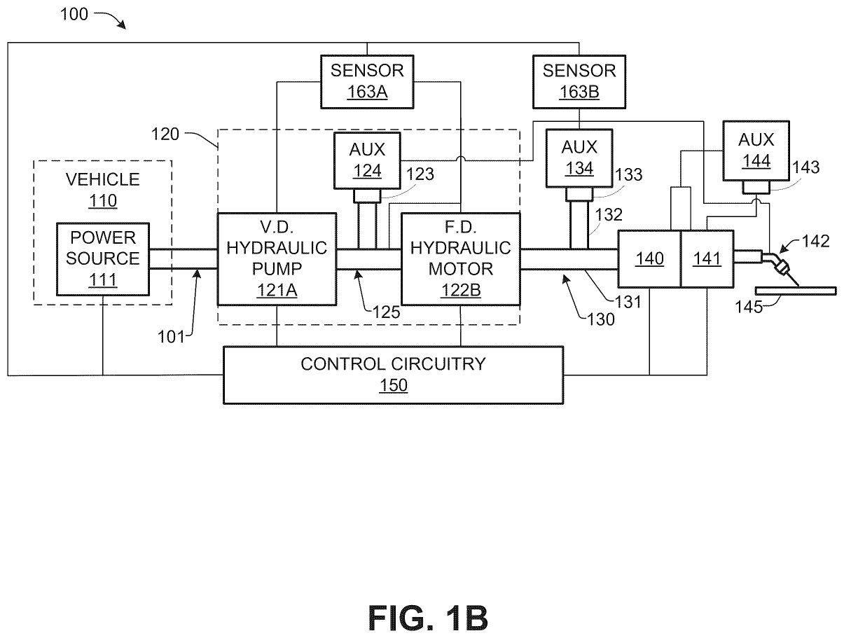

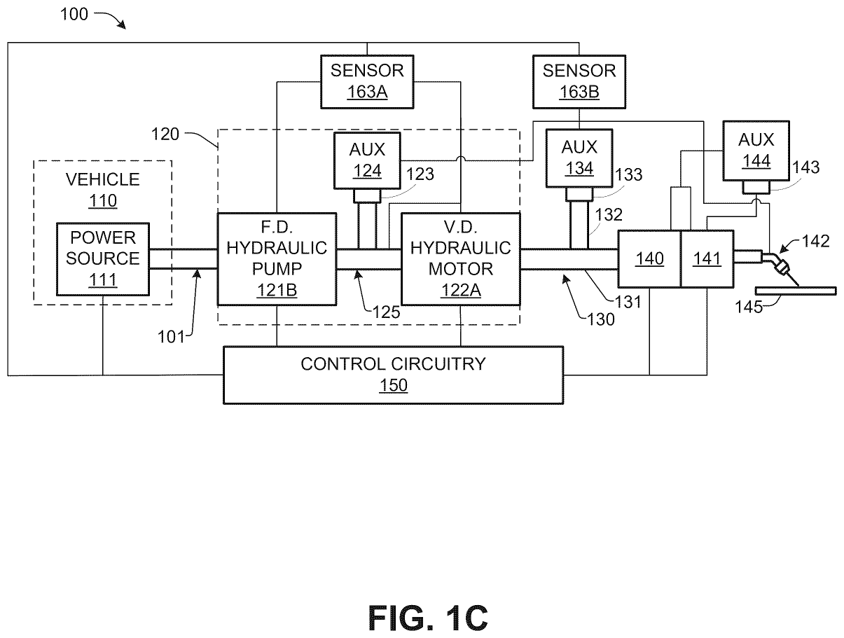

FIG. 1A is a block diagram of an example of a system 100. The system 100 is a hydraulically powered power system, and, in the example depicted in FIG. 1A, includes a power source 111, a hydraulic circuit 120, and a drive assembly 130. In the example of FIG. 1A, the system 100 further includes a control circuitry 150, which may be used to control one or more components of the system 100 (e.g., by outputting a control signal). The power source 111 generates an input power for the hydraulic circuit 120, and, thereby, provides some or all of the power used by the hydraulic circuit 120. The hydraulic circuit 120 generates a motor power for the drive assembly 130, and, thereby, provides some or all of the power used and/or transferred by the drive assembly 130. In some additional and/or alternative examples, the hydraulic circuit 120 may In some examples, the system 100 may include one, none, or any plurality of power sources (e.g., a plurality comprising the power source 111), one, none, or any plurality of hydraulic circuits (e.g., a plurality comprising the hydraulic circuit 120), and/or one, none, or any plurality of drive assemblies (e.g., a plurality comprising the drive assembly 130.

In some examples, the power source 111 is and/or includes one or more engines (e.g., one or more vehicular engines, one or more non-vehicular engines, and/or one or more other engines) and/or one or more motors (e.g., one or more electric motors, one or more vehicular motors, and/or one or more other motors). In the example of FIG. 1, the power source 111 is and/or includes an engine and/or motor of a vehicle 110 (e.g., a truck, a car, etc.). In some examples, the system 100 may include and/or receive power from any plurality of vehicles including the vehicle 110. In some examples, the system 100 does not include the vehicle 110 (e.g., the power source 111 is a free-standing power source and/or a power source of another system and/or device).

Referring to FIGS. 1A-1C, the system 100 may include one or more hydraulic pumps and/or one or more hydraulic motors. In the example of FIG. 1A, the system 100 includes a variable displacement hydraulic pump 121A and a variable displacement hydraulic motor 122A. In the example of FIG. 1B, the system 100, like the example of FIG. 1A, includes the variable displacement hydraulic pump 121A. However, in the example of FIG. 1B, the system 100 includes a fixed displacement hydraulic motor 122B (rather than, e.g., the variable displacement hydraulic motor 122A of FIG. 1A). In the example of FIG. 1C, the system 100 includes the variable displacement hydraulic motor 122A and a fixed displacement hydraulic pump 121B (rather than, e.g., the variable displacement hydraulic pump 121A).

Accordingly, it is to be understood that, in various embodiments described herein with respect to FIG. 1A, the system 100 may be modified to include one or more fixed displacement hydraulic pumps and/or one or more variable displacement hydraulic pumps in addition to the variable displacement hydraulic pump 121A, and, additionally and/or alternatively, the system 100 may be modified to include one or more fixed displacement hydraulic motors and/or one or more variable displacement hydraulic motors in addition to the variable displacement hydraulic motor 122A. It is also to be understood that, in embodiments described herein with respect to FIG. 1A, the system 100 may be modified either to replace the variable displacement hydraulic pump 121A with one or more fixed displacement hydraulic pumps (e.g., the fixed displacement hydraulic pump 121B) or to replace the variable displacement hydraulic motor 122A with one or more fixed displacement hydraulic motors (e.g., the fixed displacement hydraulic motor 122B).

Accordingly, control of the variable displacement hydraulic pump 121A and/or functionalities of the variable displacement hydraulic pump 121A, as described elsewhere herein, may be generally applicable to the example of FIG. 1A, the example of FIG. 1B (e.g., wherein the system 100 does not include the variable displacement hydraulic motor 122A), and/or one or more other examples including one or more variable displacement hydraulic pumps. Additionally, control of the variable displacement hydraulic motor 122A and/or functionalities of the variable displacement hydraulic motor 122A, as described elsewhere herein, may be generally applicable to the example of FIG. 1A, the example of FIG. 1C (e.g., wherein the system 100 does not include the variable displacement hydraulic pump 121A), and/or one or more other examples including one or more variable displacement hydraulic motors.

In the example of FIG. 1A, the variable displacement hydraulic pump 121A is drivingly coupled to the power source 111, and in the example of FIG. 1C, the fixed displacement hydraulic pump 121B is drivingly coupled to the power source 111. Accordingly, the hydraulic pumps 121A, 121B receive the input power from the power source 111 and convert the input power to an input hydraulic flow of a hydraulic fluid (e.g., hydraulic oil) within the hydraulic circuit 120. The hydraulic pumps 121A, 121B may receive the hydraulic fluid from or via, e.g., a fluid reservoir of the hydraulic circuit 120, a fluid return line of the hydraulic circuit 120, etc.

In some examples, the variable displacement hydraulic pump 121A can be controlled (e.g., by the control circuitry 150) to modify one or more pump operating characteristics of the variable displacement hydraulic pump 121A. A pump operating characteristic of the variable displacement hydraulic pump 121A may include a pump displacement (e.g., an amount of hydraulic fluid displaced per stroke, revolution, and/or one or more other intervals of a movement of a piston and/or one or more other components of the variable displacement hydraulic pump 121A, an amount of hydraulic fluid displaced by the variable displacement hydraulic pump 121A during a predefined amount of time, etc.), a pump speed (e.g., a linear and/or rotational speed of a piston or other component of the variable displacement hydraulic pump 121A), a pump torque (e.g., a rotational force generated by one or more components of the variable displacement hydraulic pump 121A), a piston force (e.g., a linear force generated by a piston or other component of the variable displacement hydraulic pump 121A), a flow rate of an input hydraulic flow generated by the variable displacement hydraulic pump 121A, and/or a flow velocity of an input hydraulic flow generated by the variable displacement hydraulic pump 121A. Accordingly, by modifying one or more pump operating characteristics of the variable displacement hydraulic pump 121A, a magnitude of a hydraulic power generated by the variable displacement hydraulic pump 121A may be modified.

One or more input linkages 101 may drivingly couple the hydraulic pumps 121A, 121B to the power source 111 by, e.g., being directly coupled to the power source 111, coupling to a drive shaft rotated by the power source 111, etc. The one or more input linkages 101 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (to, e.g., mount to a drive shaft rotated by the power source 111), one or more drive shaft couplers, and/or one or more other mechanical linkages.

The hydraulic pumps 121A, 121B pump hydraulic fluid through the hydraulic circuit 120 to provide an input hydraulic flow to hydraulic output equipment to enable the hydraulic output equipment produce an output (e.g., a motor power, compressed air, welding power, lifting power, stabilizing power, rotational power, one or more other types of mechanical and/or electrical power, etc.). As used herein, the term “hydraulic output equipment” refers to one or more devices, one or more systems, and/or one or more components that receive hydraulic power (e.g., input hydraulic flow of a hydraulic fluid) from one or more devices (e.g., one or more hydraulic pumps), systems (e.g., a hydraulic circuit), and/or components. For example, hydraulic output equipment may include one or more of any, some, or all of a hydraulic motor, an air compressor, a welder, an outrigger, a truck stabilizer, a crane, a hydraulic lift, a grinder, and/or one or more other hydraulically powered tools and/or devices.

The system 100 may include one or more hydraulic motors (e.g., either or both of the hydraulic motors 122A, 122B) and/or one or more other hydraulic auxiliary devices. In the example of FIGS. 1A-1C, the system 100 includes one or more hydraulic auxiliary devices 124, and either of the hydraulic pumps 121A, 121B provide the input hydraulic flow to the one or more hydraulic auxiliary devices 124 and either of the hydraulic motors 122A, 122B via one or more hydraulic linkages 125.

Accordingly, in the examples of FIGS. 1A and 1B, the one or more hydraulic linkages 125 hydraulically couple the variable displacement hydraulic pump 121A to the one or more hydraulic auxiliary devices 124 and either of the hydraulic motors 122A, 122B to provide the input hydraulic flow to the one or more hydraulic auxiliary devices 124 and either of the hydraulic motors 122A, 122B. In the example of FIG. 1C, the one or more hydraulic linkages 125 hydraulically couple the fixed displacement hydraulic pump 121B to the one or more hydraulic auxiliary devices 124 and the variable displacement hydraulic motor 122A to provide the input hydraulic flow to the one or more hydraulic auxiliary devices 124 and the variable displacement hydraulic motor 122A. Providing the hydraulic flow to the one or more hydraulic auxiliary devices 124 and either of the hydraulic motors 122A, 122B provides the one or more hydraulic auxiliary devices 124 and either of the hydraulic motors 122A, 122B with hydraulic power, thereby enabling one or more hydraulic auxiliary devices 124 and either of the hydraulic motors 122A, 122B to generate an output (e.g., a motor power generated by either of the hydraulic motors 122A, 122B).

In some examples, the variable displacement hydraulic motor 122A can be controlled (e.g., by the control circuitry 150) to modify one or more motor operating characteristics of the variable displacement hydraulic motor 122A. A motor operating characteristic of the variable displacement hydraulic motor 122A may include a hydraulic displacement rate (e.g., a rate at which hydraulic fluid is displaced by the variable displacement hydraulic motor 122A), a hydraulic pressure (e.g., pressure generated by the variable displacement hydraulic motor 122A in a volume of hydraulic fluid), a torque of a motor power generated by the variable displacement hydraulic motor 122A (e.g., a torque exerted on a drive shaft of the drive assembly 130), and/or a motor speed of a motor power generated by the variable displacement hydraulic motor 122A (e.g., a rotational speed of a drive shaft of the drive assembly 130). Accordingly, by modifying one or more motor operating characteristics of the variable displacement hydraulic motor 122A, a magnitude of a motor power generated by the variable displacement hydraulic motor 122A may be modified.

The one or more hydraulic linkages 125 may include, e.g., one or more pipes, one or more valves, one or more hydraulic couplers, and/or one or more other hydraulic linkages. As used herein, the term “hydraulic coupler” refers to one or more devices which may, as an independent component and/or as combination of a plurality of components, enable hydraulic output equipment (e.g., the variable displacement hydraulic motor 122A, the fixed displacement hydraulic motor 122, and/or any, some, or all of the one or more hydraulic auxiliary devices 124) external to a hydraulic circuit to couple (e.g., controllably and/or selectively couple) to the hydraulic circuit such that, once coupled, the hydraulic output equipment may receive hydraulic power (e.g., input hydraulic flow generated by the variable displacement hydraulic pump 121A).

In the examples of FIGS. 1A-1C, the hydraulic circuit 120 is hydraulically coupled to the one or more hydraulic auxiliary devices 124 by one or more hydraulic couplers 123. In some examples, the one or more hydraulic couplers 123 enable the one or more hydraulic auxiliary devices 124 to be removably coupled to the hydraulic circuit 120, e.g., so that a user of the system 100 can hydraulically power one or more external devices (e.g., the one or more hydraulic auxiliary devices 124) owned and/or provided by the user. In some examples, any, some, or all the one or more hydraulic auxiliary devices 124 are hydraulically coupled to the hydraulic circuit 120 via the one or more hydraulic couplers 129. In some examples, any, some, or all of the one or more hydraulic auxiliary devices 124 are integral components of the hydraulic circuit 120 (e.g., not requiring a hydraulic coupler to receive the input flow and/or not removably coupled to the hydraulic circuit 120).

In some examples, either of the hydraulic motors 122A, 122B may be controllably, removably, and/or selectively coupled to the hydraulic circuit 120. For example, the variable displacement hydraulic motor 122A may be controllably, removably, and/or selectively coupled to the hydraulic circuit 120 by one or more hydraulic couplers of the one or more hydraulic linkages 125. Accordingly, a user of the system 100 may, e.g., hydraulically couple their own hydraulic motor (e.g., either of the hydraulic motors 122A, 122B) and/or the user's other hydraulic output equipment to the hydraulic circuit 120 to receive input hydraulic flow.

In some examples, the one or more hydraulic auxiliary devices 124 may include one or more of any, some, or all of a hydraulic motor (e.g., one or more hydraulic motors in addition to either of the hydraulic motors 122A, 122B), an air compressor, a welder, an outrigger, a truck stabilizer, a crane, a hydraulic lift, a grinder, and/or one or more other hydraulically powered tools and/or devices. The one or more hydraulic couplers 123 may include, e.g., one or more pipes, one or more valves, and/or one or more other hydraulic linkages that can hydraulically couple the hydraulic circuit 120 to at least one of the one or more hydraulic auxiliary devices 124.

In the examples of FIGS. 1A and 1C, the variable displacement hydraulic motor 122A is drivingly coupled to a drive assembly 130, and, in the example of FIG. 1B, the fixed displacement hydraulic motor 122B is drivingly coupled to the drive assembly 130. The drive assembly 130 provides motor power to mechanical output equipment to enable the mechanical output equipment to produce an output (e.g., DC power, AC power, welding power, compressed air, lifting power, stabilizing power, rotational power, one or more other types of mechanical and/or electrical power, etc.). As used herein, the term “mechanical output equipment” refers to one or more devices, one or more systems, and/or one or more components that receive mechanical power (e.g., rotational power) from one or more devices (e.g., one or more engines, one or more electric motors, one or more hydraulic motors, and/or one or more other types of motors), systems (e.g., a power system, a drive train, etc.), and/or components. For example, mechanical output equipment may include one or more of any, some, or all of a generator, a motor, an air compressor, a welder, an outrigger, a pump, a truck stabilizer, a crane, a lift, a grinder, and/or one or more other mechanically powered tools and/or devices.

The drive assembly 130 includes one or more primary drive assembly linkages 131 to drivingly couple either of the hydraulic motors 122A, 122B to mechanical output equipment to provide motor power to the mechanical output equipment. For example, the drive assembly 130 can provide motor power to mechanical output equipment by rotating a drive shaft of the one or more primary drive assembly linkages 131, wherein the drive shaft is coupled (e.g., directly and/or via one or more linkages and/or drive shaft couplers), at a first end, to either of the hydraulic motors 122A, 122B and, at a second end, to mechanical output equipment. In some examples, the drive assembly 130 additionally includes one or more secondary drive assembly linkages 132, e.g., to enable the drive assembly 130 to provide motor power to a plurality of components, devices, and/or systems.

In the examples of FIGS. 1A-1C, the drive assembly 130 provides motor power to a generator 140 via the one or more primary drive assembly linkages 131 and to one or more mechanical auxiliary devices 134 via the one or more secondary drive assembly linkages 132.

In some additional and/or alternative examples, the one or more primary drive assembly linkages 131 may provide the motor power to any mechanical output equipment (e.g., any, some, or all of the one or more mechanical auxiliary devices 134). Any, some, or all of the drive assembly linkages 131, 132 may include one or more drive shafts, one or more clutches, one or more transmissions, one or more belts, one or more gear boxes, one or more keyway couplers, one or more splines, one or more flexible couplers, one or more spider couplers, one or more flex plates, one or more flange mounts, one or more other drive shaft mounts (e.g., to mount a drive shaft of the one or more secondary drive assembly linkages to a drive shaft of the one or more primary drive assembly linkages 131), and/or one or more other mechanical linkages and/or mechanical couplers. As used herein, the term “mechanical coupler” refers to one or more devices which may, as an independent component and/or as combination of a plurality of components, enable mechanical output equipment (e.g., the generator 140 and/or any, some, or all of the one or more mechanical auxiliary devices 134) external to a drive assembly to couple (e.g., controllably and/or selectively couple) to the drive assembly such that, once coupled, the mechanical output equipment may receive mechanical power (e.g., motor power generated by either of the hydraulic motors 122A, 122B).

In examples, the one or more mechanical auxiliary devices 134 may include one or more of any, some, or all of a generator, a motor, an air compressor, a welder, an outrigger, a pump, a truck stabilizer, a crane, a lift, a grinder, and/or one or more other mechanically powered tools and/or devices. Accordingly, by being drivingly coupled to the drive assembly 130, the one or more mechanical auxiliary devices 134 may receive motor power and convert the motor power to an output. For example, an air compressor of the one or more mechanical auxiliary devices 134 may receive the motor power and convert the motor power to a pneumatic output (e.g., compressed air). In some examples, the system 100 does not include any of the one or more mechanical auxiliary devices 134.

By being drivingly coupled to the drive assembly 130, the generator 140 may receive motor power and convert the motor power to an electrical output (e.g., AC power and/or DC power). The generator 140 may provide the electrical output to one or more tools and/or devices. The generator 140 may additionally and/or alternatively provide the electrical output to a power conversion circuitry 141 (e.g., an individual or combined generator and/or welding power supply). The generator 140 may convert the motor power to the electrical output according to one or more generator operating characteristics, such as a voltage of the electrical output (e.g., measured in volts), a frequency of the electrical output (e.g., measured in Hertz), a current of the electrical output (e.g., measured in amps), an operating speed of the generator 140 (e.g., measured in rotations per minute (“RPM”)), a load of the generator 140, and/or one or more other operating characteristics.

The power conversion circuitry 141 may be used to condition and/or regulate the electrical output of the generator 140 for usage by one or more other devices, such as by converting the electrical output to welding power. In some examples, the conditioned and/or regulated power output can be described as a synthetic auxiliary output, with the power being converted over a range of voltage and/or current output curves and/or over a range of values (e.g., 120-240 V, 15-500 amps (“A”), at 50-60 Hz). In some examples, the system 100 is configured such that the generator 140 provides a power output for the power conversion circuitry 141 to convert the electrical output from the generator 140 to a synchronous AC power output. The power conversion circuitry 141 may include one or more AC-DC converters, one or more preregulators, and/or one or more other types of converters and/or power conversion circuitries configured to convert input power (e.g., AC power) to one or more other types of power (e.g., DC power, welding power, etc.). In some examples, the power conversion circuitry 141, which receives a variable AC input from the generator 140, is configured to generate the synchronous AC power output to one or more tools and/or devices.

In some examples, the generator 140 and/or the power conversion circuitry 141 provide the electrical output to one or more tools 142 to power the one or more tools 142. The one or more tools 142 may include any, some, or all of a welding tool (e.g., a welding torch, a wire feeder, and/or one or more other components of a welding system), a wrench, and/or another device. For example, the one or more tools 142 may include a welding torch, and the power conversion circuitry 141 may provide welding power to the welding torch to perform a welding and/or cutting operation on a workpiece 145.

The generator 140 and/or the power conversion circuitry 141 may additionally and/or alternatively provide power to one or more electrical auxiliary devices 144. For example, the generator 140 may provide the electrical output to any, some or all of the electrical auxiliary devices 144 and the power conversion circuitry 141 may additionally and/or alternatively regulate the electrical output for any, some, or all of the one or more electrical auxiliary devices 144. In examples, the one or more electrical auxiliary devices 144 may include one or more of any, some, or all of a motor, an air compressor, a welder, an auxiliary tool, an outrigger, a pump, a truck stabilizer, a crane, a lift, a grinder, a wrench, lighting, and/or one or more other electrically powered tools and/or devices. In some examples, the generator 140 and/or the power conversion circuitry 141 provide power to only one of the one or more electrical auxiliary devices 144.

In some examples, the generator 140 and/or any, some, or all of the mechanical auxiliary devices 134 may be removably coupled to the drive assembly 130 by, e.g., one or more mechanical couplers 133 of the drive assembly 130. The one or more mechanical couplers 133 may include one or more drive shaft couplers, one or more drive shaft mounts, and/or one or more other mechanisms which enable mechanical output equipment to be removably coupled and de-coupled from the drive assembly 130 such that, when coupled to the one or more mechanical couplers 133, the mechanical output equipment may receive some or all of a motor power transferred via the drive assembly 130. In some examples, a user of the system 100 may, using the one or more mechanical couplers 133, drivingly couple one or more external devices (e.g., a device owned and/or provided by the user) to the drive assembly 130 via the one or more mechanical couplers 133 so that the one or more external devices can receive motor power (e.g., as one or more of the one or more mechanical auxiliary devices 134).

In some examples, any, some, or all of the electrical auxiliary devices 144 may be removably coupled to the generator 140 and/or the power conversion circuitry 141 by, e.g., one or more electrical couplers 143. The one or more electrical couplers 143 may include one or more plugs, cables, outlets, and/or one or more other mechanisms which enable electrical output equipment to be removably coupled and de-coupled from the generator 140 and/or the power conversion circuitry 141 such that, when coupled to the one or more electrical couplers 143, the electrical output equipment may receive some or all of an electrical output generated by the generator 140 and/or the power conversion circuitry 141. In some examples, a user of the system 100 may, using the one or more electrical couplers 143, electrically couple one or more external devices (e.g., a device owned and/or provided by the user) to the one or more electrical couplers 143 via the one or more electrical couplers 143 so that the one or more external devices can receive electrical power (e.g., as one or more of the one or more electrical auxiliary devices 144).

In the example of FIGS. 1A-1C, the system 100 includes the control circuitry 150. In some examples, the control circuitry 150 is and/or includes one or more control circuitries integrated into one or more components, systems, and/or devices of the system 100 (e.g., as a computing device electrically coupled to the generator 140 and integrated into a housing of the generator 140). In some additional and/or alternative examples, the control circuitry 150 is and/or includes one or more remote control circuitries (e.g., one or more cloud computing devices and/or systems, one or more cloud memory storage devices and/or systems, one or more remote controls, one or more smartphones, one or more laptops, etc.) which may, e.g., remotely transmit and/or receive signals to one or more components, systems, and/or devices of the system 100.

The control circuitry 150 may be electrically coupled to one or more devices, systems, and or components of the system 100. The control circuitry 150 may electrically communicate with one or more devices, systems, and or components by transmitting and/or receiving one or more signals (e.g., as, control signals, user interface signals, output equipment signals, input signals, etc.). The control circuitry 150 may be electrically coupled to and/or electrically communicate with any, some, or all of the vehicle 110, the power source 111, the hydraulic circuit 120, the hydraulic pumps 121A, 121B, the hydraulic motors 122A, 122B, the drive assembly 130, the generator 140, the power conversion circuitry 141, the one or more tools 142, any, some, or all of the linkages 101, 125, 131, 132, any, some, or all of the couplers 123, 133, 143, and/or any, some, or all of the auxiliary devices 124, 134, 144.

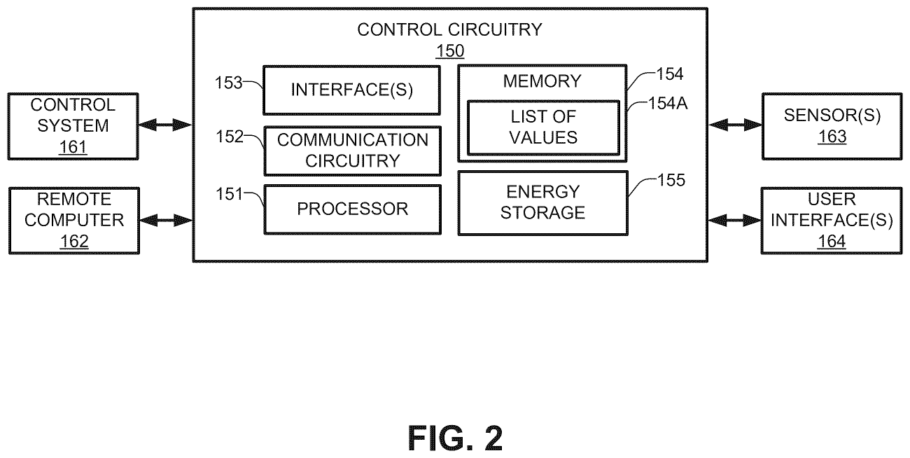

In some examples, the control circuitry 150 may directly and/or indirectly control one or more devices, systems, and/or components of the system 100. For example, the control circuitry 150 may directly control one or more devices, systems, and/or components of the system 100 (e.g., the variable displacement hydraulic pump 121A, the variable displacement hydraulic motor 122A, etc.) by transmitting a control signal that controls the one or more devices, systems, and/or components of the system 100 to modify a function, an operation, one or more operating characteristics (e.g., a pump operating characteristic of the variable displacement hydraulic pump 121A and/or a motor operating characteristic of the variable displacement hydraulic motor 122A), etc. of the one or more devices, systems, and/or components of the system 100. As an additional and/or alternative example, the control circuitry 150 may indirectly control one or more devices, systems, and/or components of the system 100 (e.g., the variable displacement hydraulic pump 121A, the variable displacement hydraulic motor 122A, etc.) by transmitting a control signal to a control circuitry and/or control system of the one or more devices, systems, and/or components of the system 100 that includes an instruction to modify a function, an operation, one or more operating characteristics (e.g., a pump operating characteristic of the variable displacement hydraulic pump 121A and/or a motor operating characteristic of the variable displacement hydraulic motor 122A), etc. of the one or more devices, systems, and/or components of the system 100 FIG. 2 is a block diagram of an example of the control circuitry 150, which can be configured as a microcontroller, or to include a processor 151, to perform as a programmable logic circuit, a system-on-chip, a programmable logic device, and/or any other type of logic circuit. The control circuitry 150 can be included in one or more components of the system 100 (e.g., the vehicle 110), the hydraulic circuit 120, the hydraulic pumps 121A, 121B, the hydraulic motors 122A, 122B, the generator 140, the power conversion circuitry 141, the one or more tools 142, any, some, or all of the auxiliary devices 124, 134, 144, etc.), and/or be implemented as one or more remote computers 162 and/or as another control device.

In some examples, the control circuitry 150 can include communication circuitry 152 (e.g., one or more transceivers) to communicate with, e.g., the vehicle 110, one or more control systems 161 (e.g., a control system of the hydraulic pumps 121A, 121B, the hydraulic motors 122A, 122B, the generator 140, the power conversion circuitry 141, the one or more tools 142, and/or any, some, or all of the auxiliary devices 124, 134, 144), the one or more remote computers 162 (e.g., one or more cloud computing devices and/or systems, one or more cloud memory storage devices and/or systems, one or more remote controls, one or more smartphones, one or more laptops, etc.), a sensor system 163, a user interface 164, one or more other devices, components, and/or systems of the system 100, etc. One or more interfaces 153 can be included with or connected to the control circuitry 150, e.g., to provide a communications link with any, some, or all of the vehicle 110, the one or more control systems 161, the remote computer 162), the sensor system 163, the user interface 164, one or more other devices, components, and/or systems of the system 100, etc.

In some examples, the control circuitry 150 includes a memory storage device 154, and/or an energy storage device 155. For example, information related to operating characteristics, target operating characteristics, measured operating characteristics, etc., can be stored in a list of values 154A, e.g., as a chart, a library, etc., within the memory storage device 154.

In some examples, the system 100 can include the user interface 164 (e.g., a switch, a knob, a trigger, a display, a keyboard, a mouse, a touchscreen, a graphical user interface, a computer input device, a sensor, etc.) to provide options for an operator to control the system 100 and/or one or more components thereof. In some examples, the user interface 164 may generate and/or transmit a user interface signal to the control circuitry 150, which may include and/or be used to determine, e.g., target operating characteristics (e.g., a target output of output equipment, a target pump operating characteristic, a target motor operating characteristic, etc.).

Additionally or alternatively, one or more components may be in direct communication with another component, for example, one or more of the various system components (e.g., the control circuitry 150) can be directly linked to any one or more of the other components (e.g., the vehicle 110, the generator 140, the power conversion circuitry 141, one or more of the tools 142, and/or any, some, or all of the auxiliary devices 124, 134, 144) to facilitate communication.

In some disclosed examples, the control circuitry 150 monitors one or more operating characteristics of the system 100 or various devices, components, and/or systems thereof. In examples, the control circuitry 150 monitors any, some, or all of the input power, the input hydraulic flow, the motor power, the electrical output, the power source 111, the hydraulic pumps 121A, 121B, the hydraulic motors 122A, 122B, the generator 140, the power conversion circuitry 141, the one or more tools 142, and/or any, some, or all of the auxiliary devices 124, 134, 144.

In some examples, the control circuitry 150 monitors one or more operating characteristics of the system 100 via a sensor system 163. The sensor system 163 may include one or more sensors, and each of the one or more sensors of the sensor system 163 may monitor one or more components and/or operating characteristics of the system 100. Each of the one or more sensors of the sensor system 163 may produce one or more input signals (e.g., a signal comprising and/or usable to determine one or more measured values and/or one or more measured operating characteristics), and each input signal may include one or more measured operating characteristics of one or more components of the system 100.

Referring again to FIGS. 1A-1C, and with reference to FIG. 2, the sensor system 163 may include any, some, or all of one or more hydraulic circuit sensors 163A, one or more output equipment sensors 163B, and/or one or more other sensors.

The one or more hydraulic circuit sensors 163A may measure operating characteristics of any, some, or all of the hydraulic circuit 120, the variable displacement hydraulic pump 121A, the fixed displacement hydraulic pump 121B, the variable displacement hydraulic motor 122A, the fixed displacement hydraulic motor 122B, and/or the one or more hydraulic linkages 125. The one or more hydraulic circuit sensors 163A may generate one or more input signals comprising the one or more measured operating characteristics to the control circuitry 150. In the examples of FIGS. 1A and 1B, the one or more hydraulic circuit sensors 163A measure one or more pump operating characteristics of the variable displacement hydraulic pump 121A. In the examples of FIGS. 1A and 1C, the one or more hydraulic circuit sensors 163A measure one or more motor operating characteristics of the variable displacement hydraulic motor 122A.

In some examples, the one or more hydraulic circuit sensors 163A measure a flow rate and/or a flow velocity of the input hydraulic flow generated by the variable displacement hydraulic pump 121A and/or within, through, and/or received by the hydraulic circuit 120, either of the hydraulic motors 122A, 122B, and/or the one or more hydraulic auxiliary devices 124. In some additional and/or alternative examples, the one or more hydraulic circuit sensors 163A measure a pressure, temperature, heat output, and/or oil weight of hydraulic fluid within the hydraulic circuit 120 and/or one or more components thereof. In some additional and/or alternative examples, the one or more hydraulic circuit sensors 163A measure a temperature, pressure, or other characteristic of an environment of the hydraulic circuit 120 and/or one or more components thereof. In examples, the one or more hydraulic circuit sensors 163A comprise any, some, or all of a flowmeter, a thermometer, a pressure sensor, a weight sensor, a torque sensor, a tachometer, a voltmeter, a photoelectric speed sensor, a Hall effect sensor, an ASIC sensor, a Hall ASIC sensor, a magnetic pickup sensor, and/or one or more other sensors (e.g., one or more sensors described elsewhere herein).

In examples, the one or more output equipment sensors 163B may measure operating characteristics of output equipment of the system 100 (e.g., any, some, or all of the auxiliary devices 124, 134, 144, the generator 140, the power conversion circuitry 141, and/or the one or more tools 142). The one or more output equipment sensors 163B may include, e.g., one or more generator sensors for measuring one or more operating characteristics of the generator 140, one or more power conversion circuitry sensors for measuring one or more operating characteristics of the power conversion circuitry 141, one or more tool sensors for measuring one or more operating characteristics of the one or more tools 142, and/or one or more auxiliary device sensors for measuring one or more operating characteristics of any, some, or all of the auxiliary devices 124, 134, 144.

An operating characteristic of output equipment measured by the one or more output equipment sensors 163B may include, e.g., a flow rate of input hydraulic flow received by the output equipment, a flow velocity of input hydraulic flow received by the output equipment, a pressure within a hydraulic circuit, a temperature of hydraulic fluid, a heat output of hydraulic fluid, an oil weight of hydraulic fluid, a temperature of an environment, an air pressure of an environment, a temperature of output equipment, an operating speed, a torque, a pneumatic output of an air compressor (e.g., an air flow rate, an air pressure, and/or one or more other air compression characteristics), a lifting power of a lift (e.g., a hydraulic lift, a mechanical lift, and/or an electrical lift), a motor power generated by a motor, a magnitude of an output of output equipment, a load demand of output equipment, a voltage of an electrical output, an amperage of an electrical output, an operating frequency of an electrical output, an operational mode of one or more devices, and/or one or more other characteristics of an output and/or function of output equipment.

In examples, the one or more output equipment sensors 163B may comprise one or more of any, some, or all of a flowmeter, a thermometer, a pressure sensor, a weight sensor, a torque sensor, an air pressure sensor, an air flow sensor, a tachometer, a voltmeter, a current sensor, an EMF sensor, a photoelectric speed sensor, a Hall effect sensor, an ASIC sensor, a Hall ASIC sensor, a magnetic pickup sensor, an electrical feedback loop, and/or one or more other sensors (e.g., one or more sensors described elsewhere herein). In examples, the one or more output equipment sensors 163B may provide one or more input signals comprising one or more measured operating characteristics (e.g., a measured pneumatic output, a measured flow velocity, a measured flow rate, a measured pressure, a measured operating speed, a measured torque, a measured load demand, a measured voltage, a measured current, a measured frequency, a measured operating state, etc.) to the control circuitry 150.

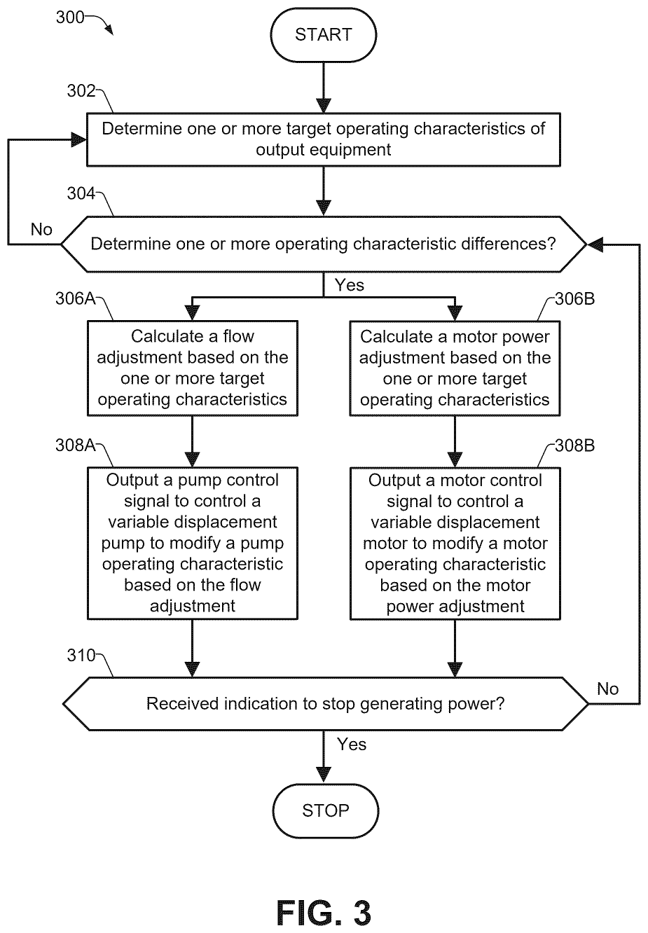

FIG. 3 is a flowchart illustrating an example of a process 300 of operating a hydraulically powered power system (e.g., the system 100). The process 300 may be implemented by control circuitry (e.g., the control circuitry 150) by executing machine-readable instructions, e.g., stored on a non-transitory machine-readable storage device (e.g., the memory storage device 154). In describing the process 300, reference will be made to the examples of FIGS. 1A-2. However, the process 300 may be used with other examples, such as alternative examples described elsewhere herein.

At a block 302 of the process 300, the control circuitry 150 determines one or more target operating characteristics of output equipment (e.g., the generator 140, the power conversion circuitry 141, the one or more tools 142, and/or any, some, or all of the auxiliary devices 124, 134, 144). For example, the control circuitry 150 may determine a target pneumatic output (e.g., a target air flow rate, a target air pressure, and/or one or more other target air compression characteristics) of an air compressor of the one or more mechanical auxiliary devices 134. In an additional and/or alternative example, the control circuitry 150 may determine a target generator operating characteristic of the generator 140 (e.g., a target voltage, a target current, a target frequency, a target operating speed, etc.). In another additional and/or alternative example, the control circuitry 150 may determine a target speed (e.g., a target upwards velocity, a target downwards velocity, and/or a target rotational velocity) of a crane of the one or more hydraulic auxiliary devices 124.

In some examples, the control circuitry 150 determines the one or more target operating characteristics based on an input signal, such as by calculating a target operating characteristic based on one or more values of the input signal and/or by an input signal including a target operating characteristic. In some examples, the control circuitry 150 receives one or more input signals generated by the generator 140, the power conversion circuitry 141, the one or more tools 142, any, some, or all of the auxiliary devices 124, 134, 144 (e.g., an air compressor), one or more control circuitries and/or user interfaces of and/or associated with output equipment of the system 100, the control system 161, the one or more remote computers 162, the sensor system 163 (e.g., any, some, or all of the sensors 163A, 163B), the user interface 164, and/or one or more other devices, systems, and/or components. The control circuitry 150 may additionally and/or alternatively determine the one or more target operating characteristics based on one or more predetermined target values, one or more predetermined target threshold values, one or more predetermined target value ranges, and/or one or more percentages.

A target operating characteristic may include any, some, or all of one or more target values (e.g., 24 volts), one or more threshold values (e.g., ≥23 volts), and/or one or more target value ranges defined by two threshold values (e.g., 23-25 volts). In some examples, a target threshold value and/or a target value range of a target operating characteristic may be determined as a function of one or more percentages of a target value of the target operating characteristic. For example, an upper target threshold voltage value may be 105% of a target value and a lower target threshold voltage value may be 95% of a target value. In some examples, an upper target threshold value of a target operating characteristic may be based on a first percentage of a target value of the target operating characteristic, while a lower target threshold value of the target operating characteristic may be based on a second percentage, different from the first percentage, of the target value. In some examples, the control circuitry 150 determines one or more percentages used for calculating one or more target threshold values and/or one or more target value ranges of a target operating characteristic based on one or more user interface signals (e.g., one or more user-input percentages) generated by the user interface 164. In some examples, the control circuitry 150 determines one or more percentages used for calculating one or more target threshold values and/or one or more target value ranges of a target operating characteristic based on one or more magnitudes of one or more target values, one or more threshold target values, and/or one or more target value ranges (e.g., a larger magnitude being associated with a smaller percentage).

At a block 304 of the process 300, the control circuitry 150 monitors one or more input signals comprising one or more measured operating characteristics of output equipment and determines one or more operating characteristic differences based at least in part on the one or more target operating characteristics and the one or more measured operating characteristics. In some examples, the control circuitry 150 determines the one or more operating characteristic differences by determining a difference between any, some, the one or more measured operating characteristics and any, some, or all of the target operating characteristics. In some examples, in the block 304, the control circuitry 150 may not determine an operating characteristic difference by, e.g., determining that the measured operating characteristic is equal to a target value, within a target range, greater than a target lower threshold value, and/or lesser than a target upper threshold value. In some such examples, the control circuitry 150 returns to the block 302 upon determining that there is no operating characteristic difference.

The control circuitry 150 may monitor one or more measured operating characteristics by monitoring one or more input signals generated by any, some, or all of the generator 140, the power conversion circuitry 141, the one or more tools 142, any, some, or all of the auxiliary devices 124, 134, 144, and/or the one or more output equipment sensors 163B. For example, the one or more measured operating characteristics may include a measured pneumatic output of an air compressor of the one or more mechanical auxiliary devices 134 (e.g., a measured air flow rate, a measured air pressure, and/or one or more other measured air compression characteristics), a measured generator operating characteristic of the generator 140 (e.g., a measured voltage, measured frequency, measured current, measured operating speed, etc.), and/or a measured speed of a crane (e.g., a measured upwards velocity, a measured downwards velocity, and/or a measured rotational velocity).

At blocks 306A, 306B of the process 300, the control circuitry 150 calculates adjustments of the variable displacement hydraulic pump 121A and the variable displacement hydraulic motor 122A, respectively. At blocks 308A, 308B of the process 300, the control circuitry outputs a control signal to modify operating characteristics of the variable displacement hydraulic pump 121A and the variable displacement hydraulic motor 122A, respectively, based on the adjustments calculated in the block 306A and the block 306B, respectively. In some examples, the process 300 does not include the blocks 306A, 308A (e.g., the example of FIG. 1C and/or one or more other examples not including the variable displacement hydraulic pump 121A). In some examples, the process 300 does not include the blocks 306B, 308B (e.g., the example of FIG. 1B and/or one or more other examples not including the variable displacement hydraulic motor 122A). In some examples, the process 300 includes all of the blocks 306A, 306B, 308A, 308B (e.g., the example of FIG. 1A and/or one or more other examples including both the variable displacement hydraulic pump 121A and the variable displacement hydraulic motor 122A).

At the block 306A, the control circuitry 150 calculates a flow adjustment based on at least one of the one or more target operating characteristics of the output equipment (e.g., a target pneumatic output and/or a target generator operating characteristic). A flow adjustment may comprise one or more adjustments of one or more flow characteristics of input hydraulic flow generated by a hydraulic pump (e.g., the variable displacement hydraulic pump 121A). In some examples, a flow adjustment is a desired change to one or more flow characteristics (e.g., an increase in flow rate), and the flow adjustment may be used to determine one or more modifications of one or more pump operating characteristics (e.g., an increase in pump displacement calculated to cause the increase in flow rate). A flow adjustment may additionally and/or alternatively comprise one or more adjustments of one or more pump operating characteristics of a hydraulic pump (e.g., the variable displacement hydraulic pump 121A). In some examples, a flow adjustment comprises one or more flow rate adjustments (e.g., an adjustment of flow rate of input hydraulic flow generated by the variable displacement hydraulic pump 121A), one or more flow velocity adjustments (e.g., an adjustment of a flow velocity of input hydraulic flow generated by the variable displacement hydraulic pump 121A), one or more flow pressure adjustments (e.g., an adjustment of a hydraulic pressure of input hydraulic flow generated by the variable displacement hydraulic pump 121A), one or more flow temperature adjustments (e.g., an adjustment of a temperature of input hydraulic flow generated by the variable displacement hydraulic pump 121A), one or more adjustments of one or more other flow characteristics of an input hydraulic flow generated by a hydraulic pump (e.g., the variable displacement hydraulic pump 121A), one or more pump displacement adjustments (e.g. an adjustment of a pump displacement of the variable displacement hydraulic pump 121A), one or more pump speed adjustments (e.g., an adjustment of the variable displacement hydraulic pump 121A), one or more pump torque adjustments (e.g., an adjustment of a pump torque of the variable displacement hydraulic pump 121A), one or more piston force adjustments (e.g., an adjustment of a piston force of the variable displacement hydraulic pump 121A), and/or one or more other pump operating characteristics of a hydraulic pump (e.g., the variable displacement hydraulic pump 121A).

In some examples, the flow adjustment is calculated to modify one or more flow characteristics (e.g., a flow rate, a flow velocity, etc.) of an input hydraulic flow generated by the variable displacement hydraulic pump 121A such that at least one of one or more measured operating characteristics of either of the hydraulic motors 122A, 122B and/or the one or more hydraulic auxiliary devices 124 (e.g., a crane) are brought closer to, equal to, and/or within a range of one or more target operating characteristics. In some examples, the flow adjustment is calculated to modify a magnitude of a motor power generated by either of the hydraulic motors 122A, 122B (e.g., by modifying a magnitude of hydraulic power received by either of the hydraulic motors 122A, 122B) such that one or more measured operating characteristics of the generator 140, the power conversion circuitry 141, the one or more tools 142, and/or any, some, or all of the auxiliary devices 134, 144 (e.g., an air compressor and/or a crane) are brought closer to, equal to, and/or within a range of one or more target operating characteristics.

In some examples, the flow adjustment is calculated based on one or more measured flow characteristics (e.g., a measured flow rate, a measured flow velocity, etc.) of input hydraulic flow generated by the variable displacement hydraulic pump 121A, one or more measured pump operating characteristics of the variable displacement hydraulic pump 121A, and/or the one or more operating characteristic differences of the block 304. For example, a magnitude of an operating characteristic difference may determine a percentage by which a measured flow characteristic of input hydraulic flow should be adjusted (e.g., an increase in a flow rate of input hydraulic flow). In some such examples, a flow adjustment is calculated by multiplying a measured flow characteristic and/or one or more measured pump operating characteristics by the percentage and/or by otherwise calculating the measured flow characteristic and/or the one or more measured pump operating characteristics using the percentage. In some examples, the control circuitry 150 determines a measured flow characteristic of the input hydraulic flow based on an input signal, e.g., generated by the one or more hydraulic circuit sensors 163A. In some examples, the control circuitry 150 determines one or more measured operating characteristics of the variable displacement hydraulic pump 121A based on an input signal, e.g., generated by the one or more hydraulic circuit sensors 163A.

In some examples, the control circuitry 150 calculates the flow adjustment as being a predetermined value, such as a predetermined incremental increase associated with a measured operating characteristic being less than a target operating characteristic or a predetermined incremental decrease associated with a measured operating characteristic being greater than a target operating characteristic. In some examples, the control circuitry 150 calculates the flow adjustment as a function of one or more operating characteristic differences, such as by calculating a flow rate increase having a magnitude proportional to a magnitude of one or more operating characteristics.

At the block 308A, the control circuitry 150 outputs a control signal to control the variable displacement hydraulic pump 121A to modify one or more pump operating characteristics of the variable displacement hydraulic pump 121A based on the flow adjustment calculated in the block 306A. For example, the control circuitry 150 may modify a pump displacement of the variable displacement hydraulic pump 121A (e.g., an amount of hydraulic fluid displaced per stroke, revolution, and/or one or more other intervals of a movement of a piston and/or one or more other components of the variable displacement hydraulic pump 121A, an amount of hydraulic fluid displaced by the variable displacement hydraulic pump 121A during a predefined amount of time, etc.), a pump speed of the variable displacement hydraulic pump 121A (e.g., a linear and/or rotational speed of a piston or other component of the variable displacement hydraulic pump 121A), a pump torque of the variable displacement hydraulic pump 121A (e.g., a rotational force generated by one or more components of the variable displacement hydraulic pump 121A), a piston force of the variable displacement hydraulic pump 121A (e.g., a linear force generated by a piston or other component of the variable displacement hydraulic pump 121A), a flow rate of an input hydraulic flow generated by the variable displacement hydraulic pump 121A, and/or a flow velocity of an input hydraulic flow generated by the variable displacement hydraulic pump 121A.

By modifying one or more pump operating characteristics of the variable displacement hydraulic pump 121A, the control circuitry 150 may bring one or more measured operating characteristics of output equipment closer to, equal to, and/or within a range of at least one of one or more target operating characteristics of output equipment. Modifying one or more pump operating characteristics of the variable displacement hydraulic pump 121A modifies a magnitude of hydraulic power generated by the variable displacement hydraulic pump 121A and, thereby, a magnitude of hydraulic power received by either of the hydraulic motors 122A, 122B and/or the one or more hydraulic auxiliary devices 124. Modifying the magnitude of hydraulic power received by either of the hydraulic motors 122A, 122B and/or the one or more hydraulic auxiliary devices 124 will modify one or more operating characteristics of either of the hydraulic motors 122A, 122B and/or the one or more hydraulic auxiliary devices 124 (e.g., a magnitude of motor power and/or another output). Accordingly, modifying one or more pump operating characteristics of the variable displacement hydraulic pump 121A may, for example, modify a speed of a crane of the one or more hydraulic auxiliary devices 124 by modifying a magnitude of the hydraulic power generated by the variable displacement hydraulic pump 121A and, thereby, received by the crane. As an additional and/or alternative example, modifying one or more pump operating characteristics of the variable displacement hydraulic pump 121A may modify a pneumatic output of an air compressor of the one or more mechanical auxiliary devices 134 by modifying a magnitude of the motor power generated by either of the hydraulic motors 122A, 122B and, thereby, received by the air compressor. As an additional and/or alternative example, modifying one or more pump operating characteristics of the variable displacement hydraulic pump 121A may modify one or more generator operating characteristics of the generator 140 by modifying a magnitude of the motor power generated by either of the hydraulic motors 122A, 122B and, thereby, received by the generator 140.

At the block 306B, the control circuitry 150 calculates a motor power adjustment based on at least one of the one or more target operating characteristics of the output equipment (e.g., a target pneumatic output and/or a target generator operating characteristic). A motor power adjustment is an adjustment of a magnitude of a motor power generated by the variable displacement hydraulic motor 122A. A magnitude of a motor power may include, e.g., a motor speed of the variable displacement hydraulic motor 122A (measured in, e.g., RPM), a rotational speed of a drive shaft of the drive assembly 130 (measured in, e.g., RPM), a torque generated by the variable displacement hydraulic motor 122A, and/or a torque exerted upon a drive shaft of the drive assembly 130. In some examples, the motor power adjustment is calculated to modify a magnitude of a motor power generated by the variable displacement hydraulic motor 122A such that one or more measured operating characteristics of the one or more mechanical auxiliary devices 134 (e.g., an air compressor and/or a crane) and/or the generator 140 are brought closer to, equal to, and/or within a range of at least one of the one or more target operating characteristics. In some examples, the motor power adjustment is calculated to modify a magnitude of a motor power generated by the variable displacement hydraulic motor 122A and, thereby, a magnitude of electrical power generated by the generator 140 such that one or more measured operating characteristics of the power conversion circuitry 141, the one or more tools 142, and/or the one or more electrical auxiliary devices 144 are brought closer to, equal to, and/or within a range of at least one of the one or more target operating characteristics.

In some examples, the motor power adjustment is calculated based on a measured motor power (e.g., a measured rotational speed and/or a measured torque) of motor power generated by the variable displacement hydraulic motor 122A, one or more measured motor operating characteristics of the variable displacement hydraulic motor 122A, and/or the one or more operating characteristic differences of the block 304. For example, a magnitude of an operating characteristic difference may determine a percentage by which the measured motor power should be adjusted, and the motor power adjustment may be calculated by multiplying the measured motor power and/or the one or more measured motor operating characteristics by the percentage. In some examples, the control circuitry 150 determines a measured motor power based on an input signal, e.g., generated by the one or more output equipment sensors 163B. In some examples, the control circuitry 150 determines one or more measured operating characteristics of the variable displacement hydraulic motor 122A based on an input signal, e.g., generated by any, some, or all of the sensors 163A, 163B.

In some examples, the control circuitry 150 calculates the motor power adjustment as being a predetermined value, such as a predetermined incremental increase associated with a measured operating characteristic being less than a target operating characteristic or a predetermined incremental decrease associated with a measured operating characteristic being greater than a target operating characteristic. In some examples, the control circuitry 150 calculates the motor power adjustment as a function of one or more operating characteristic differences, such as by calculating a motor power increase having a magnitude proportional to a magnitude of one or more operating characteristics.

At the block 308B, the control circuitry 150 outputs a control signal to control the variable displacement hydraulic motor 122A to modify one or more motor operating characteristics of the variable displacement hydraulic motor 122A based on the motor power adjustment calculated in the block 306B. For example, the control circuitry 150 may modify a hydraulic displacement rate of the variable displacement hydraulic motor 122A (e.g., a rate at which hydraulic fluid is displaced by the variable displacement hydraulic motor 122A), a hydraulic pressure of the variable displacement hydraulic motor 122A (e.g., pressure generated by the variable displacement hydraulic motor 122A in a volume of hydraulic fluid), a torque of a motor power generated by the variable displacement hydraulic motor 122A, and/or a motor speed of a motor power generated by the variable displacement hydraulic motor 122A.

By modifying one or more motor operating characteristics of the variable displacement hydraulic motor 122A, the control circuitry 150 may bring one or more measured operating characteristics of output equipment closer to, equal to, and/or within a range of at least one of one or more target operating characteristics of output equipment. Modifying one or more motor operating characteristics of the variable displacement hydraulic motor 122A modifies a magnitude of motor power generated by the variable displacement hydraulic motor 122A and, thereby, a magnitude of motor power received by the one or more mechanical auxiliary devices 134 and/or the generator 140. Modifying the magnitude of motor power received by the one or more mechanical auxiliary devices 134 and/or the generator 140 will modify one or more operating characteristics of the one or more mechanical auxiliary devices 134 (e.g., an air compressor and/or a crane) and/or the generator 140. Accordingly, modifying one or more motor operating characteristics of the variable displacement hydraulic motor 122A may, for example, modify a pneumatic output of an air compressor of the one or more mechanical auxiliary devices 134 by modifying a magnitude of the motor power received by the air compressor. As an additional and/or alternative example, modifying one or more motor operating characteristics of the variable displacement hydraulic motor 122A may modify one or more generator operating characteristics of the generator 140 by modifying a magnitude of the motor power received by the generator 140. Modifying one or more motor operating characteristics of the variable displacement hydraulic motor 122A may, additionally and/or alternatively, modify one or more operating characteristics of the power conversion circuitry 141, the one or more tools 142, and/or the one or more electrical auxiliary devices 144 by modifying a magnitude of electrical power generated by the generator 140 and, thereby, received by the power conversion circuitry 141, the one or more tools 142, and/or the one or more electrical auxiliary devices 144.

In some examples, the process 300 ends after the block 308A and/or the block 308B. In some examples, the process 300 continuously reiterates any, some, or all of the blocks 302, 304, 306A, 308A, 306B, 306B until a trigger event (e.g., receiving an instruction or control signal).

At a block 310 of the process 300, the control circuitry 150 checks for receipt of an indication to stop generating power (e.g., hydraulic power and/or motor power) and/or to stop the process 300. In some examples, the control circuitry 150 receives an input signal from the user interface 164 (generated by, e.g., a user using the user interface 164) indicating that the variable displacement hydraulic pump 121A should stop generating hydraulic power, that the variable displacement hydraulic motor 122A should stop generating motor power, and/or that the control circuitry 150 should cease conducting the process 300. In some examples, the control circuitry 150 receives a signal from the one or more control systems 161, the one or more remote computers 162, and/or one or more other control circuitries indicating that the variable displacement hydraulic pump 121A should stop generating hydraulic power, that the variable displacement hydraulic motor 122A should stop generating motor power, and/or that the control circuitry 150 should cease conducting the process 300. In some examples, the process 300 does not include the block 310.

As used herein, the term “electric motor” includes any device capable of converting electrical power (e.g., alternating current (“AC”) power and/or direct current (“DC”) power) into linear or rotary motion.

The term “power” is used throughout this specification, for convenience, to describe hydraulic power, mechanical power, electrical power, and/or one or more other types of power. However, the term “power,” as used herein, also includes related measures, aspects, and/or qualities of hydraulic power, mechanical power, electrical power, and/or one or more types of power. For example, controlling “hydraulic power” may involve controlling a flow rate of a hydraulic fluid, a flow velocity of a hydraulic fluid, a pressure of hydraulic fluid, a temperature of a hydraulic fluid, a heat output of a hydraulic fluid, and/or an oil weight of a hydraulic fluid. As another example, controlling “mechanical power” may involve controlling a rotational speed, a rotational acceleration, a rotational force, a linear speed, a linear acceleration, and/or a linear force. As yet another example, controlling “electrical power” may involve controlling voltage, current, energy, resistance, conductance, and/or enthalpy. Accordingly, controlling based on “power” may involve controlling based on any, some, or all of controlling a flow rate, flow velocity, pressure, temperature, heat output, oil weight, rotational speed, rotational acceleration, rotational force, linear speed, linear acceleration, linear force, voltage, current, energy, resistance, conductance, and/or enthalpy.

As used herein, the term “welding-type power” refers to power suitable for welding, plasma cutting, induction heating, air carbon arc cutting (“CAC-A”) and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the terms “torch,” “welding torch,” “welding tool,” and “welding-type tool” can include a hand-held or robotic welding torch, gun, or other device used to create the welding arc.

As used herein, the term “electrode” includes any consumable or non-consumable material which may be controllably provided to a welding torch by welding equipment and which may conduct a weld current (e.g., welding wire).

As used herein, the term “welding mode” refers to the type and/or modality of process and/or output used by a welding system, such as constant current (“CC”) welding, constant voltage (“CV”) welding, pulse welding, metal inert gas (“MIG”) welding or gas metal arc welding (“GMAW”), tungsten inert gas (“TIG”) welding or gas tungsten arc welding (“GTAW”), flux cored arc welding (“FCAW”), shielded metal arc welding (“SMAW”, or “stick welding”), plasma cutting, spray welding, short circuit transfer welding, etc.

As used herein, the term “welding operation” refers to a process of welding one or more materials, components, etc. using one or more welding modes.

As used herein, the terms “welding system” and “welding-type system” refer to systems capable of generating and/or conditioning welding power and/or of conducting a welding operation (e.g., by generating, conditioning, and/or receiving welding power). A welding system or welding-type system may operate and/or be capable of operating in only one welding mode and/or in any plurality of welding modes.

As used herein, the term “boost converter” refers to a converter used in a circuit that boosts a voltage. For example, a boost converter can be a type of step-up converter, such as a DC-to-DC power converter that steps up voltage while stepping down current from its input (e.g., from an energy storage device) to its output (e.g., a load and/or attached power bus). It is a type of switched mode power supply.

As used herein, the term “buck converter” (e.g., a step-down converter) refers to a power converter which steps down voltage (e.g., while stepping up current) from its input to its output.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (“DSP”) processor, an application-specific integrated circuit (“ASIC”), a graphic processing unit (“GPU”), a reduced instruction set computer (“RISC”) processor with an advanced RISC machine (“ARM”) core, etc. The processor may be coupled to, and/or integrated with a memory storage device.

As utilized herein the terms “circuits,” “circuitry,” “controller,” and “control circuitry” refer to physical electronic components (i.e., hardware) and any software and/or firmware (“code”) which may configure the hardware, be executed by the hardware, and/or otherwise be associated with the hardware. As used herein, for example, a “circuit” may comprise any analog and/or digital components, power and/or control elements (such as a microprocessor, digital signal processor (“DSP”), software, and the like), discrete and/or integrated components, associated software, hardware, and/or firmware, and/or portions and/or combinations thereof. As used herein, for example, a particular processor and memory storage device may comprise a first “circuit” when executing a first set of one or more lines of code and may comprise a second “circuit” when executing a second set of one or more lines of code. As utilized herein, circuitry is “operable” to, “configurable to,” and/or “configured to” perform a function whenever the circuitry comprises the necessary hardware and code (if any is necessary) to perform the function, regardless of whether performance of the function is disabled or not enabled (for example, by an operator-configurable setting, factory trim, etc.).

As used herein, the term “communication circuitry” refers to physical electronic components (i.e., hardware) and, in some examples, any software and/or firmware (i.e., code) which may configure the hardware, be executed by the hardware, and/or otherwise enable the hardware to communicate with one or more other devices (e.g., with communication circuitry of such one or more other devices). Communication circuitry may include hardware capable of wired and/or wireless communication with one or more other devices. Hardware capable of wired communication may include, e.g., one or more cables or other optical communication mechanisms, one or more computer buses, and/or one or more additional wired mechanisms for communicating with one or more communications networks and/or one or more devices. Hardware capable of wireless communications may include, e.g., one or more transceivers, one or more antennas, one or more modems, one or more local area network (“LAN”) ports, one or more wireless fidelity (“Wi-Fi”) cards, one or more WiMax cards, mobile communications hardware, near-field communication hardware, satellite communication hardware, hardware configured to communicate in accordance with one or more wireless communication protocols (e.g., IrDA, Bluetooth, Wireless USB, Z-Wave, ZigBee, radio frequency identification (“RFID”), one or more other near field communications (“NFC”) protocols, and/or one or more other protocols for close-proximity and/or wireless communication), and/or other hardware for wirelessly communicating with one or more communications networks and/or one or more devices. Communication circuitry may include one or more network interfaces, one or more input-output (“I/O”) interfaces, and/or one or more other interfaces for communicating data (e.g., directly, via one or more communications paths, etc.) to and/or from one or more communications networks. An example network interface may include hardware, firmware, and/or software to communicatively couple communication circuitry to one or more communications networks. A network interface may include and/or be coupled to one or more communication paths. A communication path includes hardware which provides signal interconnectivity between one or more components (e.g., control circuitry and a transceiver). A network interface may include any hardware for transmitting and/or receiving communications (e.g., IEEE 802.X-compliant wireless and/or wired communications hardware). An example I/O interface includes hardware, firmware, and/or software to connect one or more I/O devices to control circuitry (communicatively coupled to, e.g., communication circuitry comprising the I/O interface) for providing input to the control circuitry and/or providing output from the control circuitry. For example, the I/O interface may include a graphics processing unit for interfacing with a display device, a universal serial bus port for interfacing with one or more USB-compliant devices, a FireWire, a field bus, and/or any other type of interface. Example I/O device(s) may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device. Control circuitry communicatively coupled to an I/O interface may access a non-transitory machine-readable medium via the I/O interface and/or one or more I/O device(s). Examples of a machine-readable medium include optical discs (e.g., compact discs (“CDs”), digital versatile/video discs (“DVDs”), Blu-ray discs, etc.), magnetic media (e.g., floppy disks), portable storage media (e.g., portable flash drives, secure digital (“SD”) cards, etc.), and/or any other type of removable and/or installed machine-readable media.

A “communications network” may include one or more of the Internet, one or more personal area networks (“PAN(s)”), one or more LANs, one or more wide area networks (“WAN(s)”), one or more cellular networks, one or more satellite networks, one or more global positioning systems, one or more other such networks, and/or any combination thereof. A LAN may include, e.g., one or more wired technologies (e.g., Ethernet, USB, etc.) and/or one or more wireless technologies (e.g., Wi-Fi). A PAN may include one or more wired technologies (e.g., USB, FireWire, and/or one or more other computer buses) and/or one or more wireless technologies (e.g., Bluetooth, Wireless USB, IrDA, Z-Wave, ZigBee, RFID, one or more other NFC protocols, and/or one or more other protocols for close-proximity and/or wireless communication). A cellular network may include, e.g., technologies such as LTE, WiMAX, UMTS, CDMA, GSM, 3G, 4G, 5G, 6G, and/or one or more other technologies.

As used, herein, the term “memory,” “memory storage device,” “storage device,” and/or “memory device” means computer hardware or circuitry to store information for use by a processor and/or other digital device. The memory, memory storage device, and/or memory device can be any suitable type of computer memory or any other type of electronic storage medium, such as, for example, read-only memory (“ROM”), random access memory (“RAM”), cache memory, compact disc read-only memory (“CDROM”), electro-optical memory, magneto-optical memory, programmable read-only memory (“PROM”), erasable programmable read-only memory (“EPROM”), electrically-erasable programmable read-only memory (“EEPROM”), a computer-readable medium, or the like. Memory can include, for example, a non-transitory memory, a non-transitory processor readable medium, a non-transitory computer readable medium, non-volatile memory, dynamic RAM (“DRAM”), volatile memory, ferroelectric RAM (“FRAM”), first-in-first-out (“FIFO”) memory, last-in-first-out (“LIFO”) memory, stack memory, non-volatile RAM (“NVRAM”), static RAM (“SRAM”), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (“SIM”) card, a hard drive (“HDD”), a solid state drive (“SSD”), etc. The memory, memory storage device, and/or memory device can be configured to store code, instructions, applications, software, firmware, and/or data, and may be external, internal, or both with respect to a processor.

Features described herein make reference to the accompanying drawings in which exemplary embodiments of the disclosure are shown. However, it should be understood that the systems of this disclosure can be embodied in many different forms and should not be construed as limited to the embodiments set forth herein.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Unless otherwise expressly stated, it is in no way intended than any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As used herein, the word “exemplary” means serving as a non-limiting example, instance, or illustration. The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation. As utilized herein, the terms “e.g.” and “for example” set off lists of one or more non-limiting examples, instances, or illustrations.

While the present method, apparatus, and/or system has been described with reference to certain implementations, it will be understood by those skilled in the art that various changes, modifications, and variations may be made to the present disclosure and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A hydraulically powered power system, comprising:
a variable displacement hydraulic pump configured to receive input power from an engine or an electric motor and to convert the input power to an input hydraulic flow;
a hydraulic motor configured to convert the input hydraulic flow to motor power;
a compressor configured to receive the motor power to generate a pneumatic output; and
control circuitry configured to:
calculate a flow adjustment based on a target pneumatic output of the compressor; and
upon calculating the flow adjustment, output a pump control signal to control the variable displacement hydraulic pump to modify a pump operating characteristic of the variable displacement hydraulic pump based on the flow adjustment.

2. The hydraulically powered power system of claim 1, wherein the pump operating characteristic comprises at least one of a pump displacement of the variable displacement hydraulic pump, a pump speed of the variable displacement hydraulic pump, a pump torque of the variable displacement hydraulic pump, a piston force of the variable displacement hydraulic pump, a flow rate of the input hydraulic flow generated by the variable displacement hydraulic pump, or a flow velocity of the input hydraulic flow generated by the variable displacement hydraulic pump.

3. The hydraulically powered power system of claim 1, wherein the control circuitry is further configured to:
receive an input signal; and
determine the target pneumatic output based on the input signal.

4. The hydraulically powered power system of claim 1, further comprising a hydraulic auxiliary device configured to receive the input hydraulic flow and to convert the input hydraulic flow to an output, wherein the calculating of the flow adjustment is further based on a target output of the hydraulic auxiliary device.

5. The hydraulically powered power system of claim 1, further comprising a hydraulic auxiliary device configured to convert the input hydraulic flow to an output, wherein the calculating of the flow adjustment is further based on a target output of the hydraulic auxiliary device.

6. The hydraulically powered power system of claim 1, further comprising a mechanical auxiliary device configured to receive the motor power to generate an output, wherein the calculating of the flow adjustment is further based on a target output of the mechanical auxiliary device.

7. The hydraulically powered power system of claim 1, wherein:
the hydraulic motor is a variable displacement hydraulic motor; and
the control circuitry is further configured to:
calculate a motor power adjustment based on the target pneumatic output; and
upon calculating the motor power adjustment, output a motor control signal to control the variable displacement hydraulic motor to modify a motor operating characteristic of the variable displacement hydraulic motor based on the motor power adjustment.

8. A hydraulically powered power system, comprising:
a variable displacement hydraulic motor configured to convert an input hydraulic flow to motor power;
a compressor configured to receive the motor power to generate a pneumatic output; and control circuitry configured to:
calculate a motor power adjustment based on a target pneumatic output of the compressor; and
upon calculating the motor power adjustment, output a motor control signal to control the variable displacement hydraulic motor to modify a motor operating characteristic of the variable displacement hydraulic motor based on the motor power adjustment.

9. The hydraulically powered power system of claim 8, wherein the motor operating characteristic comprises at least one of a hydraulic displacement rate of the variable displacement hydraulic motor, a hydraulic pressure of the variable displacement hydraulic motor, a torque of the motor power, or a motor speed of the motor power.

10. The hydraulically powered power system of claim 8, wherein the motor power adjustment comprises at least one of a torque adjustment or a motor speed adjustment.

11. The hydraulically powered power system of claim 8, wherein the control circuitry is further configured to:
receive an input signal; and
determine the target pneumatic output based on the input signal.

12. The hydraulically powered power system of claim 8, further comprising a mechanical auxiliary device configured to receive the motor power to generate an output, wherein the calculating of the motor power adjustment is further based on a target output of the mechanical auxiliary device.

13. The hydraulically powered power system of claim 8, further comprising a variable displacement hydraulic pump configured to receive input power from an engine or an electric motor and to convert the input power to the input hydraulic flow, wherein the control circuitry is further configured to:
calculate a flow adjustment based on the target pneumatic output; and
upon calculating the flow adjustment, output a pump control signal to control the variable displacement hydraulic pump to modify a pump operating characteristic of the variable displacement hydraulic pump based on the flow adjustment.

14. A hydraulically powered power system, comprising:
a variable displacement hydraulic pump configured to receive input power from an engine or an electric motor and to convert the input power to an input hydraulic flow;
a hydraulic motor configured to convert the input hydraulic flow to motor power;
a generator drivingly coupled to the hydraulic motor and configured to receive the motor power to generate an electrical output;
a generator sensor configured to measure a generator operating characteristic of the generator and to generate a sensor signal comprising a measured generator operating characteristic associated with the generator operating characteristic; and
control circuitry configured to:
calculate a flow adjustment based on a target generator operating characteristic of the generator and the measured generator operating characteristic; and
upon calculating the flow adjustment, output a pump control signal to control the variable displacement hydraulic pump to modify a pump operating characteristic of the variable displacement hydraulic pump based on the flow adjustment.

15. The hydraulically powered power system of claim 14, wherein the generator operating characteristic comprises at least one of a voltage of the electrical output, a frequency of the electrical output, a current of the electrical output, or an operating speed of the generator.

16. The hydraulically powered power system of claim 14, wherein the pump operating characteristic comprises at least one of a pump displacement of the variable displacement hydraulic pump, a pump speed of the variable displacement hydraulic pump, a pump torque of the variable displacement hydraulic pump, a piston force of the variable displacement hydraulic pump, a flow rate of the input hydraulic flow generated by the variable displacement hydraulic pump, or a flow velocity of the input hydraulic flow generated by the variable displacement hydraulic pump.

17. The hydraulically powered power system of claim 14, wherein the control circuitry is further configured to:
receive an input signal; and
determine the target generator operating characteristic based on the input signal.

18. The hydraulically powered power system of claim 14, further comprising a hydraulic auxiliary device configured to convert the input hydraulic flow to an output, wherein the calculating of the flow adjustment is further based on a target output of the hydraulic auxiliary device.

19. The hydraulically powered power system of claim 14, further comprising a mechanical auxiliary device configured to receive the motor power to generate an output, wherein the calculating of the flow adjustment is further based on a target output of the mechanical auxiliary device.

20. The hydraulically powered power system of claim 14, wherein:
the hydraulic motor is a variable displacement hydraulic motor; and
the control circuitry is further configured to:
calculate a motor power adjustment based on the target generator operating characteristic of the generator and the measured generator operating characteristic; and
upon calculating the motor power adjustment, output a motor control signal to control the variable displacement hydraulic motor to modify a motor operating characteristic of the variable displacement hydraulic motor based on the motor power adjustment.

21-27. (canceled)
